(19) United States
(12) Patent Application Publication
(10) Pub. No.: US 2024/0339746 A1
(43) Pub. Date: Oct. 10, 2024

(54) ANTENNA ASSEMBLY

(71) Applicant: TE Connectivity Solutions GmbH, Schaffhausen (CH)

(72) Inventors: Rizwan KHAN, Prai (MY); Keanmeng LIM, Prai (MY); KokJiunn NG, Prai (MY); YenSiang TAN, Prai (MY)

(21) Appl. No.: 18/625,515

(22) Filed: Apr. 3, 2024

(30) Foreign Application Priority Data
Apr. 6, 2023 (MY) 2023001890

(51) Int. Cl. H01Q 1/20; H01Q 1/40; H01Q 1/42; H01Q 21/28

(52) U.S. Cl. CPC H01Q 1/20; H01Q 1/40; H01Q 1/42; H01Q 21/28

(57) ABSTRACT

An antenna assembly includes a flexible whip antenna having a mounting connector, a cable coupled to the mounting connector, a bottom spring coil surrounding the cable and coupled to the mounting connector, an adaptor coupled to the cable, and a rod radiator coupled to the adaptor. The mounting connector is coupled to an antenna feed. The cable extends between a first end, terminated to the mounting connector, and a second end, terminated to the adaptor. The bottom spring coil concentrically surrounds the first end of the cable and is terminated to the mounting connector. The rod radiator extends between a first end, terminated to the adaptor, and a second end. The cable is flexible to move the rod radiator relative to the mounting connector.

### CROSS REFERENCE TO RELATED APPLICATIONS

This application claims the benefit of Malaysian Application No. 2023001890, filed 6 Apr. 2023, the subject matter of which is herein incorporated by reference in its entirety.

### BACKGROUND OF THE INVENTION

The subject matter herein relates generally to antenna assemblies.

Various different types of antennas are used in the automotive industry, including AM/FM radio antennas, satellite digital audio radio service antenna, global positioning system antennas, cell phone antennas, and the like. The antenna assembly is operable for transmitting and/or receiving signals to/from the vehicle. Some known antennas are multiband antennas having multiple antennas to cover and operate at multiple frequency ranges. Automotive antennas may be installed or mounted on a vehicle surface, such as the roof, trunk, or hood of the vehicle to help ensure that the antennas have unobstructed views overhead or toward the zenith. The antenna may be connected via a coaxial cable to one or more electronic devices, such as a radio receiver, a touchscreen display, a navigation device, a cellular phone, an autonomous driving system, and the like. Some vehicles may utilize a whip antenna on the vehicle to cover one or more frequencies. However, it may be desirable to integrate the whip antenna with the radome of the antenna assembly. There may be limits to the height of the whip antenna, which limits the frequency bands for the whip antenna. Additionally, it is desirable that the whip antenna be flexible to avoid damage or breaking of the whip antenna when installed on the vehicle. Additionally, closely positioning of the whip antenna with other antenna elements within the radome leads to interference and reductions in antenna performance.

A need remains for an antenna assembly that is operable in multiple frequency bands.

### BRIEF DESCRIPTION OF THE INVENTION

In one embodiment, an antenna assembly is provided and includes a flexible whip antenna that includes a mounting connector, a cable coupled to the mounting connector, a bottom spring coil surrounding the cable and coupled to the mounting connector, an adaptor coupled to the cable, and a rod radiator coupled to the adaptor. The mounting connector is configured to be coupled to an antenna feed. The cable extends between a first end and a second end. The first end is terminated to the mounting connector. The second end is terminated to the adaptor. The cable is electrically connected to the antenna feed through the mounting connector. The bottom spring coil concentrically surrounds the first end of the cable. The bottom spring coil is terminated to the mounting connector. The bottom spring coil is electrically connected to the antenna feed through the mounting connector. The rod radiator extends between a first end and a second end. The first end is terminated to the adaptor. The rod radiator is electrically connected to the antenna feed through the cable. The cable is flexible to move the rod radiator relative to the mounting connector.

In another embodiment, an antenna assembly is provided and includes a flexible whip antenna that includes a mounting connector, a cable coupled to the mounting connector, a bottom spring coil surrounding the cable and coupled to the mounting connector, an adaptor coupled to the cable, and a rod radiator coupled to the adaptor. The mounting connector is configured to be coupled to an antenna feed. The bottom spring coil is terminated to the mounting connector. The bottom spring coil is electrically connected to the antenna feed through the mounting connector. The bottom spring coil having a length is ¼λ for a 7/800 Mhz frequency band. The cable extends between a first end and a second end. The first end is terminated to the mounting connector. The second end is terminated to the adaptor. The cable is electrically connected to the antenna feed through the mounting connector. The cable having a length is ¼λ for a UHF frequency band. The rod radiator extends between a first end and a second end. The first end is terminated to the adaptor. The rod radiator is electrically connected to the antenna feed through the cable. The cable, the adaptor, and the rod radiator have a combined length is less than a ¼λ for a VHF frequency band.

In a further embodiment, an antenna assembly is provided and includes an antenna base that includes a ground plane. The antenna assembly includes a radome coupled to the antenna base such that an interior enclosure is collectively defined by the radome and the antenna base. The internal enclosure is configured to hold at least one antenna element. The antenna assembly includes a whip antenna connector base mounted to the antenna base. The antenna assembly includes a flexible whip antenna coupled to the whip antenna connector base. The flexible whip antenna includes a first radiating element operable at a VHF frequency band, a second radiating element operable at a UHF frequency band, and a third radiating element operable at a 7/800 MHz frequency band.

### BRIEF DESCRIPTION OF THE DRAWINGS

FIG. 1 illustrates an antenna assembly in accordance with an exemplary embodiment.

FIG. 2 is a sectional view of a portion of the antenna assembly in accordance with an exemplary embodiment.

FIG. 3 illustrates the whip antenna in accordance with an exemplary embodiment.

FIG. 4 illustrates the whip antenna in accordance with an exemplary embodiment with the protective covers removed to illustrate the radiating elements of the whip antenna.

FIG. 5 is a cross sectional view of the whip antenna 300 in accordance with an exemplary embodiment.

FIG. 6 is an enlarged view of a top portion of the whip antenna in accordance with an exemplary embodiment.

FIG. 7 is an enlarged view of a bottom portion of the whip antenna in accordance with an exemplary embodiment.

FIG. 8 is an enlarged view of a bottom portion of the whip antenna in accordance with an exemplary embodiment.

FIG. 9 illustrates the radiating elements of the whip antenna in accordance with an exemplary embodiment.

FIG. 10 provides simulated results for the whip antenna in accordance with the embodiment shown in FIG. 9.

FIG. 11 provides simulated results for the whip antenna in accordance with the embodiment shown in FIG. 9.

FIG. 12 provides simulated results for the whip antenna in accordance with the embodiment shown in FIG. 9.

FIG. 13 provides simulated results for the whip antenna in accordance with the embodiment shown in FIG. 9.

FIG. 14 provides simulated results for the whip antenna in accordance with the embodiment shown in FIG. 9.

FIG. 15 provides simulated results for the whip antenna in accordance with the embodiment shown in FIG. 9.

FIG. 16 provides simulated results for the whip antenna in accordance with the embodiment shown in FIG. 9.

FIG. 17 provides simulated results for the whip antenna in accordance with the embodiment shown in FIG. 9.

FIG. 18 provides simulated results for the whip antenna in accordance with the embodiment shown in FIG. 9.

FIG. 19 provides simulated results for the whip antenna in accordance with the embodiment shown in FIG. 9.

FIG. 20 provides simulated results for the whip antenna in accordance with the embodiment shown in FIG. 9.

FIG. 21 provides simulated results for the whip antenna in accordance with the embodiment shown in FIG. 9.

FIG. 22 provides simulated results for the whip antenna in accordance with the embodiment shown in FIG. 9.

FIG. 23 provides simulated results for the whip antenna in accordance with the embodiment shown in FIG. 9.

FIG. 24 provides simulated results for the whip antenna in accordance with the embodiment shown in FIG. 9.

FIG. 25 provides simulated results for the whip antenna in accordance with the embodiment shown in FIG. 9.

### DETAILED DESCRIPTION OF THE INVENTION

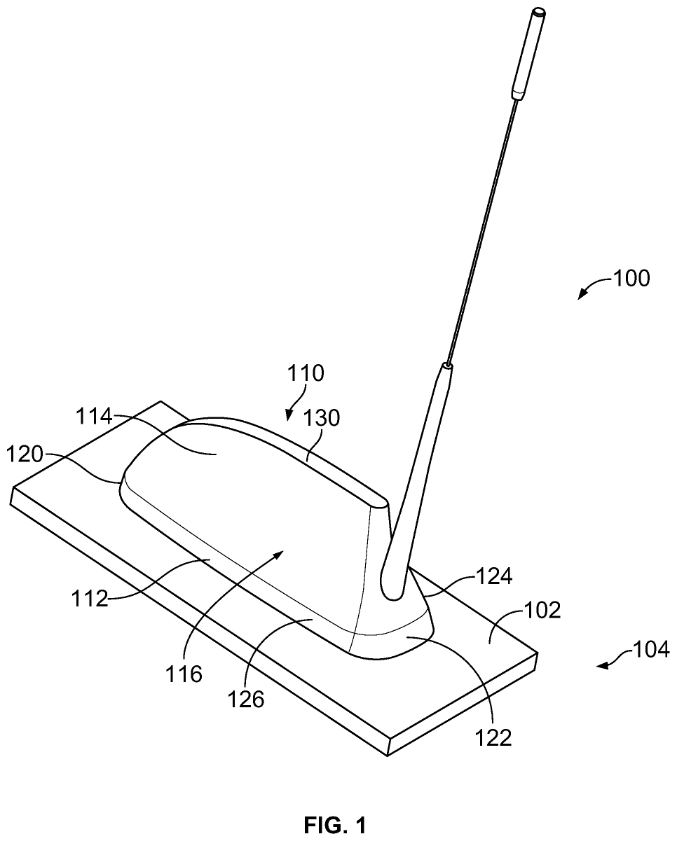

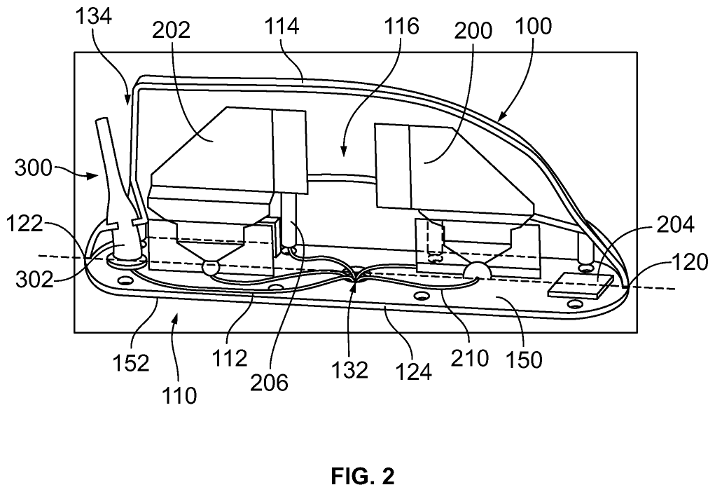

FIG. 1 illustrates an antenna assembly 100 in accordance with an exemplary embodiment. FIG. 2 is a sectional view of a portion of the antenna assembly 100 in accordance with an exemplary embodiment. In various embodiments, the antenna assembly 100 is for use in a vehicle, such as for installation on a rooftop 102 of a vehicle 104. However, the antenna assembly 100 may have application in other applications, such as in a building.

The antenna assembly 100 integrates multiple antenna elements into a common structure mounted to the vehicle 104 for a multiband antenna automotive system. For example, the antenna assembly 100 may include cellular, Wi-Fi, Dedicated Short Range Communication (DSRC), public safety, land mobile radio, and satellite antennas to provide versatility in communication for the vehicle 104. In various embodiments, the antenna assembly 100 may be operable over one or more cellular frequencies (for example, 4G, 5G, Long Term Evolution (LTE), and the like), operable over Wi-Fi frequencies, operable over terrestrial frequencies (for example, amplitude modulation (AM), frequency modulation (FM), and the like), operable over DSRC frequencies for “vehicle to everything” communication, operable over one or more satellite signals (e.g., Satellite Digital Audio Radio (SDARS), Global Navigation Satellite System (GNSS), and the like). The antenna assembly 100 may include antenna elements operable in other frequencies. The antenna elements of the antenna assembly 100 are arranged so as to avoid (or at least reduce) mutual coupling or interference and/or degradation of signals between the various antenna elements.

The antenna assembly 100 includes an antenna housing 110 holding the antenna components. The antenna housing 110 includes an antenna base 112 and a cover or radome 114 coupled to the antenna base 112. The antenna base 112 and the radome 114 form an interior enclosure 116 that receives the antenna components. Optionally, some antenna components may be located within and/or below the antenna base 112, such as circuit boards, cables, and the like. In an exemplary embodiment, one or more of the antenna elements are located above the antenna base 112, under the radome 114, inside the interior enclosure 116. The antenna elements may be mounted to the antenna base 112 and covered by the radome 114. Optionally, at least one of the antenna elements may extend through the radome 114 to the exterior of the interior enclosure. For example, the antenna assembly 100 includes an external whip antenna.

The antenna housing 110 extends between a front 120 and a rear 122. The radome 114 has a first or right side 124 and a second or left side 126 between the front 120 and the rear 122. The right side 124 and the left side 126 may be generally parallel to the central longitudinal axis of the antenna housing 110. In an exemplary embodiment, the radome 114 is aerodynamically designed. The radome 114 may have a shark-fin shape. The radome 114 has a ridge 130 extending between the front 120 and the rear 122. The ridge 130 may be generally aligned with the central longitudinal axis, such as centered between the right side 124 and the left side 126. The ridge 130 provides a space for one or more of the antenna elements. In an exemplary embodiment, the external whip antenna is located at the rear 122.

With reference to FIG. 2, the antenna base 112 includes a substrate 150. The antenna elements may be mounted to the substrate 150. For example, the substrate 150 may support the antenna elements. The substrate 150 may be a conducting material, such as a metal material. In the illustrated embodiment, the substrate 150 is obround, such as having an oval shape being curved at the front and the rear with parallel sides therebetween. The substrate 150 may have other shapes in alternative embodiments. In various embodiments, the substrate 150 is a metal plate. For example, the substrate 150 may be a die-cast component. The substrate 150 may be mounted to the vehicle 104, such as to the rooftop 102 of the vehicle 104. In an exemplary embodiment, the substrate 150 includes and/or defines a ground plane 152 to provide a ground reference for the antenna elements. In various embodiments, the substrate may be a circuit board having one or more circuits, such as a ground circuit defining the ground plane 152 and one or more feed circuits to feed the antenna elements. For example, the antenna elements may be soldered to circuits or conductors of the circuit board. Alternatively, the feeds for the antenna elements may be provided by feed cables passing through the substrate 150, such as through an opening 154.

In an exemplary embodiment, the antenna assembly 100 includes a first or primary cellular antenna 200 configured to be operable over one or more cellular frequencies, a second or secondary cellular antenna 202 configured to be operable over one or more cellular frequencies, a satellite antenna 204 configured to be operable over one or more satellite frequencies, one or more Wi-Fi antennas 206 configured to be operable over one or more Wi-Fi frequencies, and a whip antenna 300 configured to be operable over terrestrial frequencies and/or public safety frequencies and/or LMR frequencies. The antennas 200, 202, 204, 206, 300 are mounted to the antenna base 112, such as to the substrate 150. The antenna base 112 provides multiple mounting locations for the various antenna elements.

In an exemplary embodiment, the first and second cellular antennas 200, 202 are monopole antennas. In an exemplary embodiment, the Wi-Fi antennas 206 are monopole antennas. In the illustrated embodiment, the Wi-Fi antennas 206 are standalone Wi-Fi antennas mounted to the antenna base 112 separate from the cellular antennas 200, 202. However, in alternative embodiments, one or more of the Wi-Fi antennas 206 may be integrated Wi-Fi antennas integrated with the cellular antennas 200, 202. The satellite antenna 204 may be a patch antenna.

In an exemplary embodiment, feed cables 210 are terminated to the antenna elements. The feed cables 210 may be coaxial cables. The feed cables 210 pass through the opening 154 in the substrate 150 for connection to the corresponding antenna elements.

In an exemplary embodiment, the first and second cellular antennas 200, 202 are multiple-in, multiple-out (MIMO) antenna elements that cover wide frequency bands. In an exemplary embodiment, the first and second cellular antennas 200, 202 are arranged along the central longitudinal axis. For example, the first cellular antenna 200 is located closer to the front 120 and the second cellular antenna 202 is located closer to the rear 122. The first and second cellular antennas 200, 202 may be approximately centered between the first side 124 and the second side 126.

In an exemplary embodiment, the satellite antenna 204 is arranged along the central longitudinal axis. For example, the satellite antenna 204 may be located forward of the first and second cellular antennas 200, 202, such as proximate to the front 120. In various embodiments, the satellite antenna 204 has a short profile and is positionable at the nose of the radome 114. However, other locations are possible in alternative embodiments, such as between the first and second cellular antennas 200, 202 or proximate to the rear 122.

In an exemplary embodiment, the Wi-Fi antennas 206 are mounted to the antenna base 112 offset from the central longitudinal axis, such as closer to the right side 124 or closer to the left side 126. The Wi-Fi antennas 206 may flank the cellular antennas 200, 202. However, other locations are possible in alternative embodiments.

In an exemplary embodiment, the whip antenna 300 is arranged along the central longitudinal axis. For example, the whip antenna 300 may be located rearward of the first and second cellular antennas 200, 202, such as proximate to the rear 122. The whip antenna 300 may be a monopole antenna. The whip antenna 300 may be omni-directional having 360° signal coverage. In various embodiments, the whip antenna 300 is configured to pass through an opening 132 in the radome 114 to the exterior of the radome 114. The radome 114 may include a rear pocket 134 at the rear 122. Other locations are possible in alternative embodiments. In an exemplary embodiment, a whip antenna connector base 302 mounted to the antenna base 112. The whip antenna connector base 302 is located within the interior enclosure 116. The whip antenna connector base 302 extends to the opening 132. The whip antenna 300 is coupled to the whip antenna connector base 302 at the opening 132 and is located in the rear pocket 134. For example, the whip antenna connector base 302 may include a threaded stud and the whip antenna 300 may be threadably coupled to the whip antenna connector base 302.

In an exemplary embodiment, the first and second cellular antennas 200, 202 cover a broad frequency range to meet bandwidth requirements, such as to cover the 4G cellular network and/or the 5G cellular network and/or the LTE cellular network. For example, the first and second cellular antennas 200, 202 may cover a frequency range from approximately 617 MHz to 7125 MHz. In various embodiments, the first and second cellular antennas 200, 202 may be designed for targeted operation in both the 617-960 MHz range and the 1690-7125 MHz range. In an exemplary embodiment, the satellite antenna 204 is used for satellite positioning, such as for use with a GPS system of the vehicle. The satellite antenna 204 may be a dual band (L1 and L5) antenna element. The satellite antenna 204 may have a low axial ratio to provide high precision positioning for assisted driving and self-driving. In an exemplary embodiment, the satellite antenna 204 may be used for satellite radio. In various embodiments, the satellite antenna 204 may cover one or more frequency ranges, such as a frequency range from approximately 1559.052-1607 MHz and/or 1166-1186 MHz. In an exemplary embodiment, the Wi-Fi antennas 206 may be used for Wi-Fi communication and or Bluetooth communication in and around the vehicle. In various embodiments, the Wi-Fi antennas 206 may cover one or more frequency ranges, such as a frequency range from approximately 2400-2500 MHz and/or 4900-7125 MHz. The Wi-Fi antennas 206 may cover the Bluetooth Low Energy 2.4 GHz-2.48 GHz frequency range. In an exemplary embodiment, whip antenna 300 may be used for terrestrial communication e.g., two-way radio or land mobile radio system. In various embodiments, the whip antenna 300 may cover one or more frequency ranges, such as the VHF, UHF, and 700-800 MHz bands. In an exemplary embodiment, the antenna elements may be used for communication with the surroundings, such as vehicle-to-vehicle communication, vehicle-to-infrastructure communication, vehicle-to-pedestrian communication, and the like.

In an exemplary embodiment, the antenna base 112 of the antenna assembly 100 has a relatively small footprint and the antenna elements are positioned in close proximity to each other to fit within the footprint. The antenna elements are positioned relative to each other such that there is sufficient de-correlation, sufficiently low coupling, and sufficient isolation between the antenna elements. The antenna elements are positioned relative to each other to fit within the radome 114 (for example, within the shark-fin shape of the radome 114). For example, placement of the antenna elements is positioned based on height, width, and length dimensions of the antenna elements to fit within the interior enclosure of the radome 114 while limiting matching or coupling between the antenna elements for efficient operation of the various antenna elements.

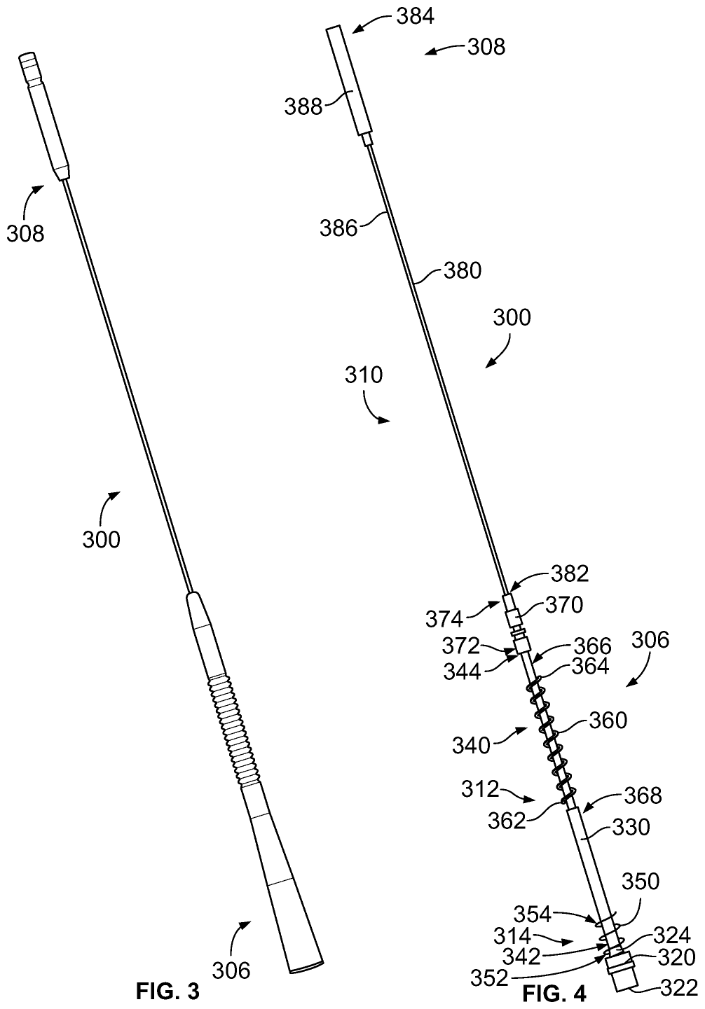

FIG. 3 illustrates the whip antenna 300 in accordance with an exemplary embodiment. The whip antenna 300 is a monopole antenna. The whip antenna 300 includes multiple elements for operation in multiple frequency bands. For example, the different elements have their own resonance for specific frequencies. The whip antenna 300 is flexible to prevent damage during bending or manipulation.

The whip antenna 300 includes a lower portion 306 and an upper portion 308. The lower portion 306 is configured to be mounted to the whip antenna connector base 302 (shown in FIG. 2). For example, the lower portion 306 may be threadably coupled to the threaded stud of the whip antenna connector base 302. In an exemplary embodiment, the lower portion 306 is flexible to allow the upper portion 308 to move relative to the whip antenna connector base 302. In various embodiments, the lower portion 306 may be bent approximately 90° or more. The upper portion 308 may additionally be flexible. In an exemplary embodiment, the whip antenna 300 includes one or more protective covers covering the radiating elements to protect the radiating elements.

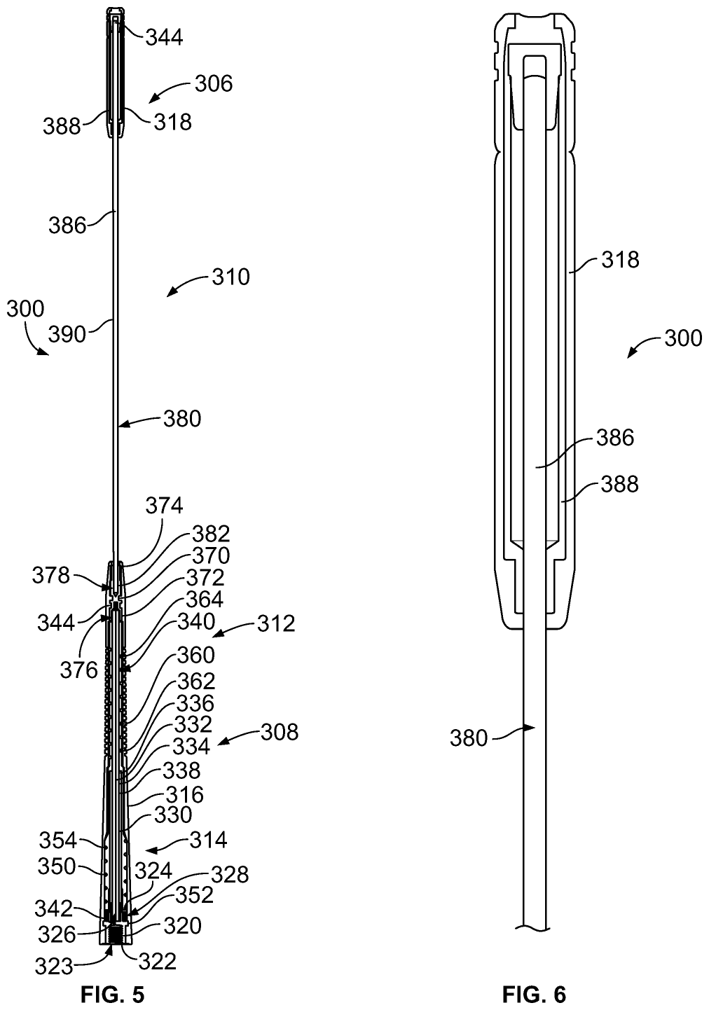

FIG. 4 illustrates the whip antenna 300 in accordance with an exemplary embodiment with the protective covers removed to illustrate the radiating elements of the whip antenna 300. FIG. 5 is a cross sectional view of the whip antenna 300 in accordance with an exemplary embodiment.

In an exemplary embodiment, the whip antenna 300 includes a first radiating element 310 operable at a VHF frequency band, a second radiating element 312 operable at a UHF frequency band, and a third radiating element 314 operable at a 7/800 MHz frequency band. For example, the first radiating element 310 may be operable at approximately 150-160 MHz, the second radiating element 312 may be operable at approximately 450-512 MHz, and the third radiating element 314 may be operable at approximately 745-870 MHz. The whip antenna 300 may include greater or fewer radiating elements in alternative embodiments.

In an exemplary embodiment, the whip antenna 300 includes one or more protective covers covering the radiating elements 310, 312, 314. For example, the whip antenna 300 includes a lower protective cover 316 (FIG. 5) covering the lower portion 306 and an upper protective cover 318 (FIG. 5) covering the upper portion 308. The protective covers 316, 318 may be coatings, shells, overmolds, or other types of protective covers.

In an exemplary embodiment, the whip antenna 300 includes a mounting connector 320, a cable 330 coupled to the mounting connector 320, a bottom spring coil 350 surrounding the cable 330 and coupled to the mounting connector 320, a parasitic spring coil 360 surrounding the cable 330, an adaptor 370 coupled to the cable 330, and a rod radiator 380 coupled to the adaptor 370.

The mounting connector 320 extends between a first end 322 and a second end 324. The mounting connector 320 includes a threaded bore 323 at the first end 322. The threaded bore 323 is configured to receive the threaded stud of the whip antenna connector base 302 to mechanically and electrically connect the mounting connector 320 to the whip antenna connector base 302. In an exemplary embodiment, the mounting connector 320 includes an inner barrel 326 and an outer barrel 328 at the second end 324. The inner barrel 326 receives the cable 330. The outer barrel 328 receives the bottom spring coil 350. The inner barrel 326 may be soldered or crimped to the cable 330 to mechanically and electrically connect the mounting connector 320 to the cable 330. The outer barrel 328 may be soldered or crimped to the bottom spring coil 350 to mechanically and electrically connect the mounting connector 320 to the bottom spring coil 350. The mounting connector 320 may include other features to connect to the cable 330 and/or the bottom spring coil 350.

In an exemplary embodiment, the cable 330 is a coaxial cable being both flexible and operating as a radiating element of the whip antenna 300. The cable 330 includes an inner conductor 332, an insulator 334 surrounding the inner conductor 332, an outer conductor 336 surrounding the insulator 334, and a jacket 338 surrounding the outer conductor 336. In an exemplary embodiment, the cable 330 includes a stripped portion 340 where the jacket 338 and the outer conductor 336 are stripped or removed from the cable 330. The cable 330 extends between a first end 342 and a second end 344. The first end 342 is configured to be coupled to the mounting connector 320. The second end 344 is configured to be coupled to the adaptor 370. In an exemplary embodiment, the stripped portion 340 is provided at the second end 344. In various embodiments, the stripped portion 340 may extend for approximately half of the length of the cable 330. However, the stripped portion 340 may be greater than or less than half the length of the cable 330 in other embodiments. The cable 330 is flexible to allow movement of the adaptor 370 and the rod radiator 380 relative to the mounting connector 320. In various embodiments, the cable 330 may be configured to bend 90° or more to change the orientation of the rod radiator 380 relative to the vehicle. In an exemplary embodiment, the cable 330 is an RG-58 cable; however, other types of coaxial cables may be used in alternative embodiments.

The bottom spring coil 350 is provided at the bottom of the whip antenna 300. The bottom spring coil 350 is coupled to the mounting connector 320 and concentrically surrounds the cable 330. The bottom spring coil 350 extends between a first end 352 and a second end 354. The first end 352 is coupled to the mounting connector 320. The bottom spring coil 350 includes a plurality of windings helically wound around the cable 330. The number of windings and the overall length of the bottom spring coil 350 affects the resonance of the whip antenna 300. In an exemplary embodiment, the bottom spring coil 350 defines the third radiating element 314 of the whip antenna 300. The bottom spring coil 350 is a helical radiating element. The bottom spring coil 350 corresponds to the 700/800 Mhz band. The length of the bottom spring coil 350 may be selected to tune the third radiating element 314 to a particular frequency bandwidth, such as between approximately 745-870 MHz. For example, the length of the bottom spring coil 350 may be selected to be ¼λ for the 700/800 Mhz band. In various embodiments, the bottom spring coil 350 may be capacitively coupled to the cable 330 to affect the resonance of the whip antenna 300. For example, the capacitive coupling between the cable 330 and the bottom spring coil 350 may help widen the bandwidth of the third radiating element 314.

The parasitic spring coil 360 extends along a portion of the cable 330. In an exemplary embodiment, the parasitic spring coil 360 extends along the stripped portion 340 of the cable 330. The parasitic spring coil 360 extends between a first end 362 and a second end 364. The parasitic spring coil 360 includes a plurality of windings helically wound around the cable 330. The number of windings and the overall length of the parasitic spring coil 360 affects the resonance of the whip antenna 300. In an exemplary embodiment, a gap 366 is provided between the second end 364 of the parasitic spring coil 360 and the adaptor 370. The length of the gap 366 affects the resonance of the whip antenna 300. In an exemplary embodiment, a gap 368 is provided between the first end 362 and the bottom spring coil 350. The length of the gap 368 affects the resonance of the whip antenna 300.

In an exemplary embodiment, the cable 330 and the parasitic spring coil 360 define the second radiating element 312. The resonating structure defined by the cable 330 and the parasitic spring coil 360 corresponds to the UHF band. The lengths of the cable 330 and the parasitic spring coil 360 may be selected to tune the second radiating element 312 to a particular frequency bandwidth, such as between approximately 450-512 MHz. For example, the length of the cable 330 may be selected to be ¼λ for a UHF frequency band. In various embodiments, the parasitic spring coil 360 may be capacitively coupled to the cable 330 to affect the resonance of the whip antenna 300. For example, the capacitive coupling between the cable 330 and the parasitic spring coil 360 may help widen the bandwidth of the second radiating element 312.

The adaptor 370 extends between a first end 372 and a second end 374. The adaptor 370 includes a cable barrel 376 at the first end 372. The cable barrel 376 is configured to receive the second end 344 of the cable 330 to mechanically and electrically connect the cable 330 to the adaptor 370. The cable barrel 376 may be soldered or crimped to the end of the cable 330. In an exemplary embodiment, the adaptor 370 includes a rod barrel 378 at the second end 374. The rod barrel 378 receives the rod radiator 380. The rod barrel 378 may be soldered or crimped to the rod radiator 380 to mechanically and electrically connect the adaptor 370 to the rod radiator 380. The adaptor 370 may include other features to connect to the cable 330 and/or the rod radiator 380.

The rod radiator 380 extends between a first end 382 and a second end 384. The rod radiator 380 includes a metal rod 386 at the first end 382 and a metal tube 388 at the second end 384. The metal rod 386 extends into the metal tube 388. The metal rod 386 extends into the second end 374 of the adaptor 370. For example, the metal rod 386 extends into the rod barrel 378. The rod barrel 378 may be soldered or crimped to the metal rod 386 to mechanically and electrically connect the adaptor 370 to the metal rod 386. The metal tube 388 may be crimped or soldered to the end of the metal rod 386. In an exemplary embodiment, the metal rod 386 is a stainless-steel rod. In various embodiments, a protective coating 390 surrounds the metal rod 386. In an exemplary embodiment, the metal rod 386 is flexible to allow movement of the metal tube 388 at the top end of the rod radiator 380 relative to the adaptor 370.

FIG. 6 is an enlarged view of a top portion of the whip antenna 300 in accordance with an exemplary embodiment. FIG. 6 illustrates the metal tube 388 at the end of the metal rod 386. In an exemplary embodiment, the metal tube 388 is hollow and receives the end of the metal rod 386. The metal tube 388 is crimped to the metal rod 386 to position the metal tube 388 relative to the metal rod 386. The length of the metal tube 388 is selected to affect the resonance of the rod radiator 380, such as to target a particular frequency band. The spacing of the metal tube 388 relative to the metal rod 386 is selected to affect the resonance of the rod radiator 380, such as to target a particular frequency band.

In an exemplary embodiment, the upper protective cover 318 is provided to cover the metal tube 388 and the metal rod 386. In an exemplary embodiment, the upper protective cover 318 is overmolded over the metal tube 388 after the metal tube 388 is attached to the metal rod 386. The upper protective cover 318 surrounds the metal tube and the end of the metal rod 386 to enclose the top end of the rod radiator 380 and protects the components from the external environment.

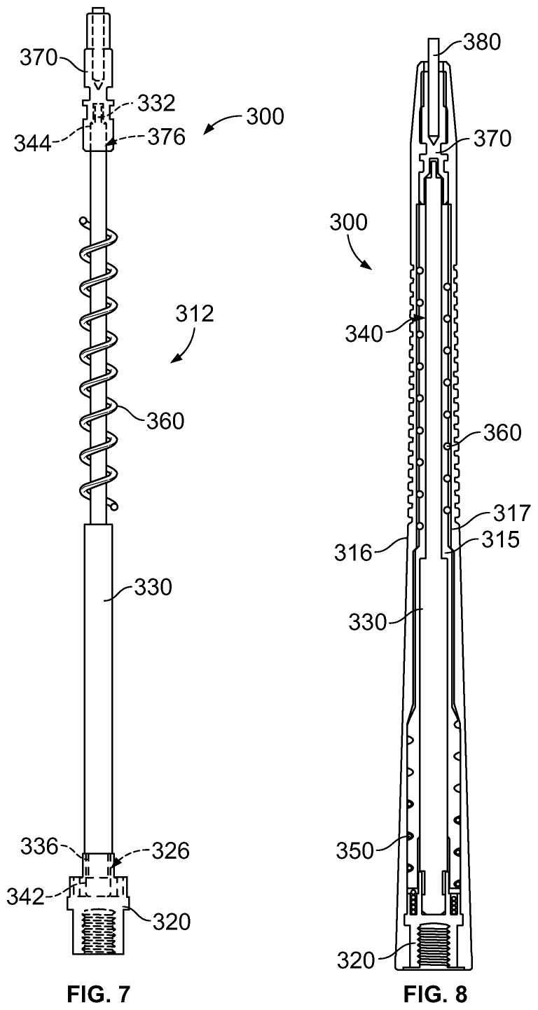

FIG. 7 is an enlarged view of a bottom portion of the whip antenna 300 in accordance with an exemplary embodiment. FIG. 7 illustrates the cable 330 between the mounting connector 320 and the adaptor 370. The first end 342 of the cable 330 is received in the inner barrel 326 and terminated to the mounting connector 320. The second end 344 of the cable 330 is received in the cable barrel 376 and terminated to the adaptor 370.

In an exemplary embodiment, the mounting connector 320 is electrically conductive to electrically connect the antenna feed to the cable 330. In an exemplary embodiment, the inner conductor 332 and the outer conductor 336 are direct coupled to each other at the mounting connector 320. For example, the mounting connector 320 may be soldered or crimped to both the inner conductor 332 and the outer conductor 336 within the inner barrel 326. The inner conductor 332 and the outer conductor 336 form a radiator for the whip antenna 300. The length of the outer conductor 336 along the inner conductor 332 is selected to tune the second radiating element 312. The length of the parasitic spring coil 360 and the positioning of the parasitic spring coil 360 along the cable 330 is selected to tune the second radiating element 312. The cable 330 operates as an effective radiator for the whip antenna 300 while additionally being flexible to allow movement of the adaptor 370 relative to the mounting connector 320.

FIG. 8 is an enlarged view of a bottom portion of the whip antenna 300 in accordance with an exemplary embodiment. FIG. 8 illustrates the lower protective cover 316 on the bottom portion of the whip antenna 300. The lower protective cover 316 covers the mounting connector 320, the cable 330, the bottom spring coil 350, the parasitic spring coil 360, and the adaptor 370.

In an exemplary embodiment, the lower protective cover 316 includes an inner cover portion 315 and an outer cover portion 317. The outer cover portion 317 covers the inner cover portion 340. The inner cover portion 315 supports various components relative to each other. The outer cover portion 317 protects the various components from the external environment. In an exemplary embodiment, the inner cover portion 315 is insert molded on the cable 330, the bottom spring coil 350, and the parasitic spring coil 360. The inner cover portion 315 fixes the position of the bottom spring coil 350 and the parasitic spring coil 360 relative to the cable 330. In various embodiments, the inner cover portion 315 is applied to the cable 330 prior to connecting the cable 330 to the mounting connector 320 and the adaptor 370. In an exemplary embodiment, after the cable 330 is connected to the mounting connector 320 and the adaptor 370, the outer cover portion 317 may be applied to the overall assembly. For example, the outer cover portion 317 may be overmolded over the mounting connector 320, the cable 330, the bottom spring coil 350, the parasitic spring coil 360, the adaptor 370, and the inner cover portion 315. In various embodiments, the outer cover portion 370 may be overmolded over the adaptor 370 after the rod radiator 380 is terminated to the adaptor 370. The outer cover portion 370 may extend along at least a portion of the rod radiator 380.

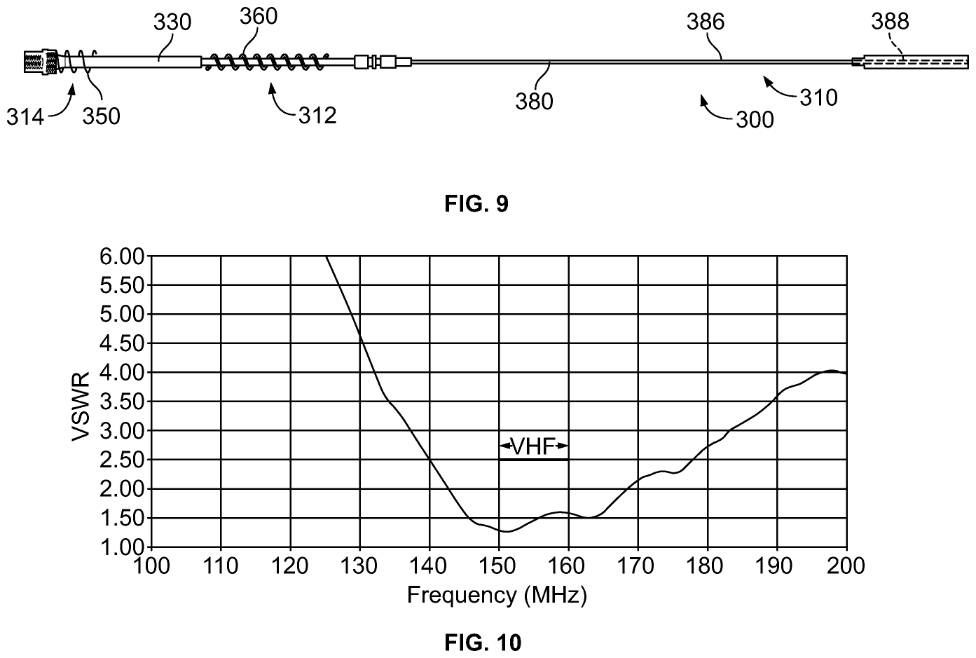

FIG. 9 illustrates the radiating elements 310, 312, 314 of the whip antenna 300 in accordance with an exemplary embodiment. The components of the whip antenna 300 cooperate to form the radiating elements 310, 312, 314 within a single antenna structure. The bottom spring coil 350 generally defines the third radiating element 314. The cable 330 and the parasitic spring coil 360 generally define the second radiating element 312. The rod radiator 380 and the cable 330 generally define the first radiating element 310. The first radiating element 310 is operable at a VHF frequency band (such as 150-160 MHz), the second radiating element 312 is operable at a UHF frequency band (such as 450-512 MHz), and the third radiating element 314 is operable at a 7/800 MHZ frequency band (such as 745-870 MHz).

In an exemplary embodiment, the overall antenna length may be approximately 416 mm, which is less than a typical length of 509 mm to achieve the VHF band of (150-160 MHz). The antenna structure of the whip antenna 300 allows the shortening of the overall antenna length while still achieving operation in the VHF band (150-160 MHz). For example, the additional loading from the outer conductor 336 of the cable 330 and the use of the helical radiator of the parasitic spring coil 360 on the stripped section of the cable 330 provide additional loading to achieve operation in the VHF band while allowing the overall length to be shortened. The addition of the metal tube 388 at the top end provides additional loading for the rod radiator 380 with addition coupling between metal tube 388 and the metal rod 386 to further widen the VHF band. The flexibility of the cable 330 at the bottom end of the whip antenna 300 maintains the structural flexibility of the overall antenna structure.

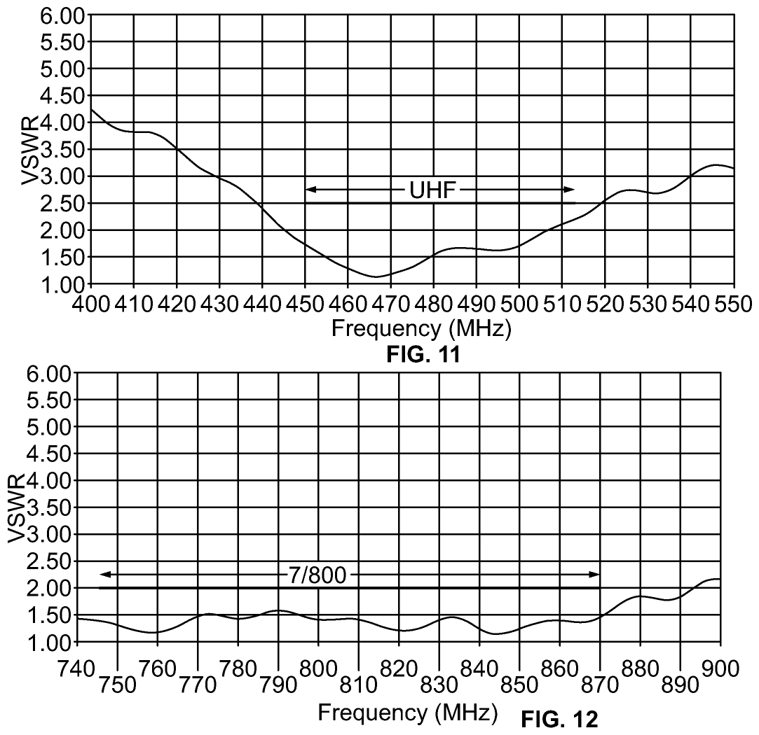

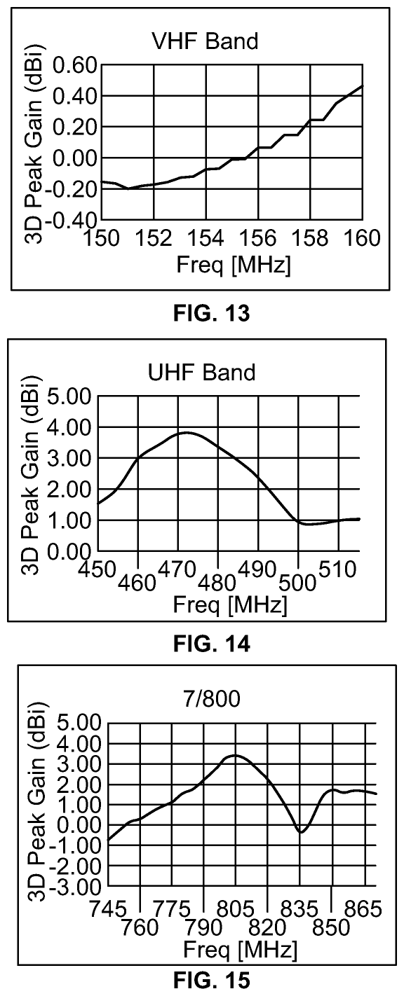

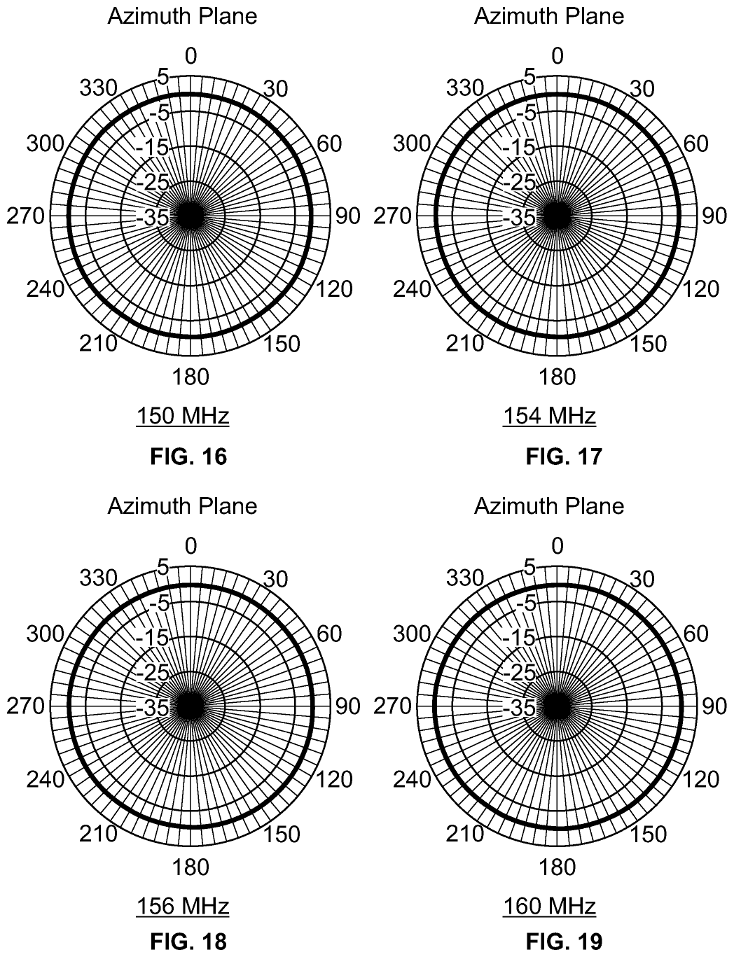

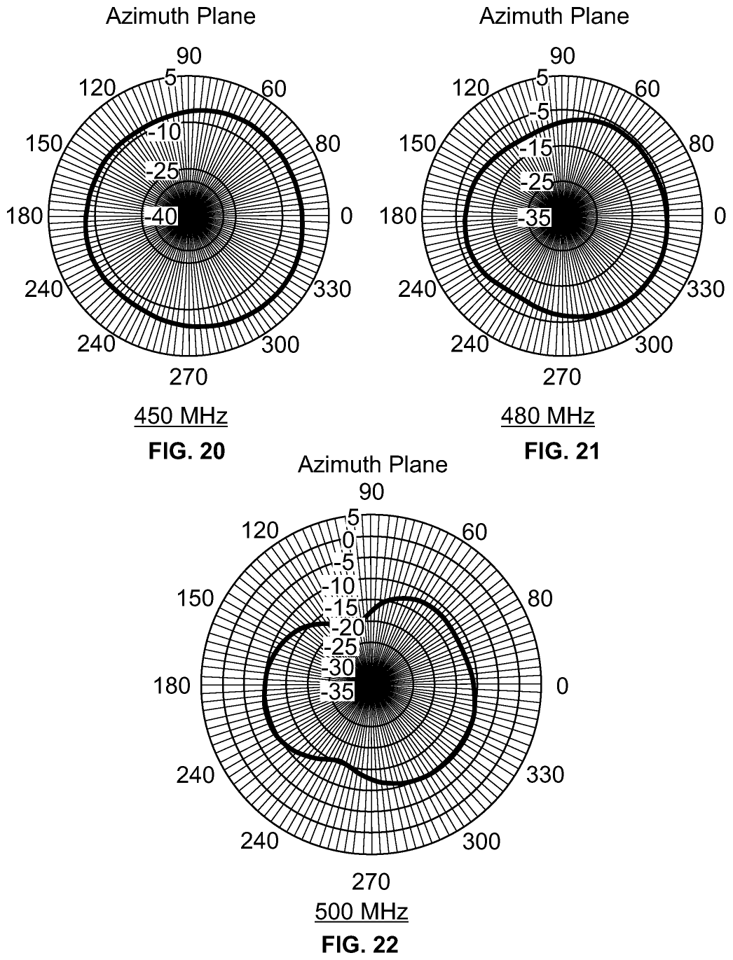

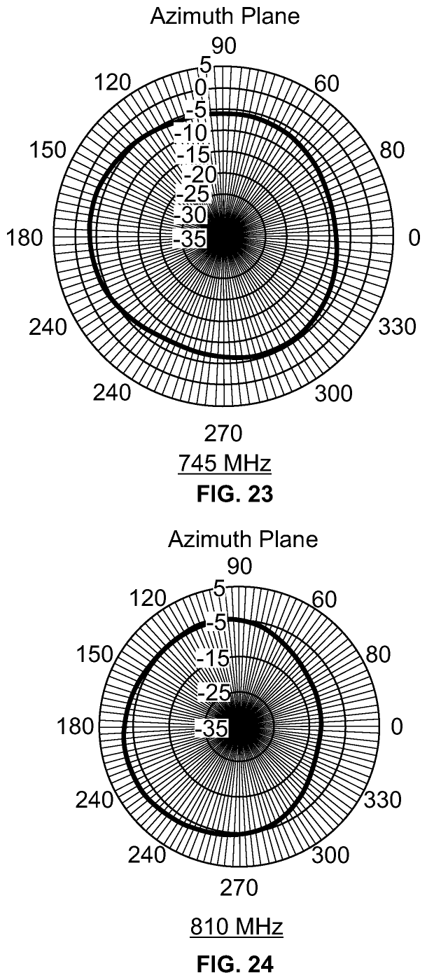

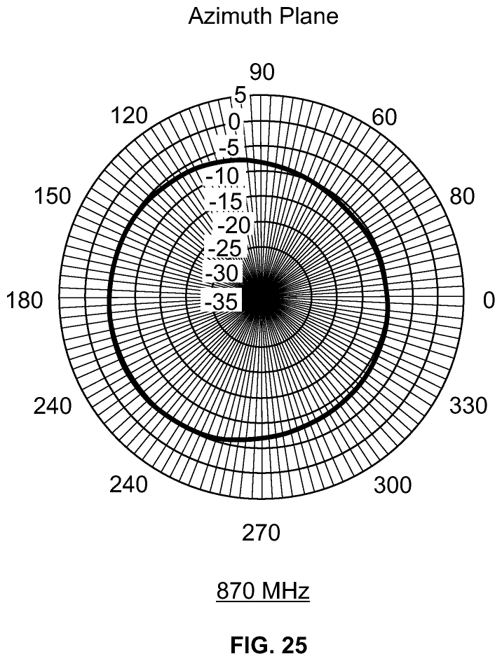

FIGS. 10-25 provide measured results for the whip antenna 300 in accordance with the embodiment shown in FIG. 9. The whip antenna 300 radiates in an omni-directional pattern for the VHF frequency band, the UHF frequency band, and the 7/800 MHz frequency band. The whip antenna 300 offers multiband coverage using a single monopole whip antenna having multiple radiating elements, such as to cover the VHF frequency band, the UHF frequency band, and the 7/800 MHz frequency band. FIGS. 10-12 show VSWR results for the VHF frequency band, the UHF frequency band, and the 7/800 MHz frequency band, respectively. FIGS. 13-15 show the peak gain for the VHF frequency band, the UHF frequency band, and the 7/800 MHz frequency band, respectively. FIGS. 16-25 show radiation patterns for the whip antenna 300 at various frequencies in the VHF frequency band, the UHF frequency band, and the 7/800 MHZ frequency band. The analysis results shown in FIGS. 10-25 are provided for purposes of illustration and not for purposes of limitation. Alternative embodiments of the whip antenna may be configured differently and have different operational or performance parameters than what is shown in FIGS. 10-25.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An antenna assembly comprising:
a flexible whip antenna including a mounting connector, a cable coupled to the mounting connector, a bottom spring coil surrounding the cable and coupled to the mounting connector, an adaptor coupled to the cable, and a rod radiator coupled to the adaptor;
the mounting connector is configured to be coupled to an antenna feed;
the cable extends between a first end and a second end, the first end being terminated to the mounting connector, the second end being terminated to the adaptor, the cable being electrically connected to the antenna feed through the mounting connector;
the bottom spring coil concentrically surrounds the first end of the cable, the bottom spring coil being terminated to the mounting connector, the bottom spring coil being electrically connected to the antenna feed through the mounting connector;
the rod radiator extending between a first end and a second end, the first end being terminated to the adaptor, the rod radiator being electrically connected to the antenna feed through the cable;
wherein the cable is flexible to move the rod radiator relative to the mounting connector.

2. The antenna assembly of claim 1, wherein the cable includes an inner conductor and an outer conductor, the inner conductor and the outer conductor being coupled to the mounting connector.

3. The antenna assembly of claim 2, wherein the inner conductor and the outer conductor are direct coupled to each other at the mounting connector.

4. The antenna assembly of claim 1, further comprising a parasitic spring coil concentrically surrounding a portion of the cable separate from the bottom spring coil.

5. The antenna assembly of claim 4, wherein the cable includes an inner conductor, an insulator surrounding the inner conductor, an outer conductor surrounding the insulator, and a jacket surrounding the outer conductor, the cable having a stripped portion at the second end where the outer conductor and the jacket are removed, the parasitic spring coil located along the stripped portion.

6. The antenna assembly of claim 4, wherein the parasitic spring coil is located a gap length from the adaptor.

7. The antenna assembly of claim 4, wherein the parasitic spring coil is capacitively coupled to the cable.

8. The antenna assembly of claim 1, wherein the mounting connector, the cable, the bottom spring coil, and the adaptor are contained within a common protective cover.

9. The antenna assembly of claim 1, wherein the bottom spring coil has a length being ¼λ for a 7/800 Mhz frequency band, wherein the cable has a length being ¼λ for a UHF frequency band, and wherein the cable, the adaptor, and the rod radiator having a combined length being less than ¼λ for a VHF frequency band.

10. The antenna assembly of claim 1, wherein the rod radiator includes a stainless steel rod and a dielectric coating surrounding the stainless steel rod.

11. The antenna assembly of claim 1, wherein the rod radiator includes a radiating cap at a distal end of the rod radiator and a protective cover covering the radiating cap.

12. The antenna assembly of claim 1, wherein the rod radiator has a higher elastic modulus then the cable.

13. The antenna assembly of claim 1, wherein the flexible whip antenna has an overall length of less than 420 mm and is operable at a VHF frequency band of between 150 MHz and 160 MHz.

14. An antenna assembly comprising:
a flexible whip antenna including a mounting connector, a cable coupled to the mounting connector, a bottom spring coil surrounding the cable and coupled to the mounting connector, an adaptor coupled to the cable, and a rod radiator coupled to the adaptor;
the mounting connector is configured to be coupled to an antenna feed;
the bottom spring coil being terminated to the mounting connector, the bottom spring coil being electrically connected to the antenna feed through the mounting connector, the bottom spring coil having a length being ¼λ for a 7/800 Mhz frequency band;
the cable extends between a first end and a second end, the first end being terminated to the mounting connector, the second end being terminated to the adaptor, the cable being electrically connected to the antenna feed through the mounting connector, the cable having a length being ¼λ for a UHF frequency band;
the rod radiator extending between a first end and a second end, the first end being terminated to the adaptor, the rod radiator being electrically connected to the antenna feed through the cable;
wherein the cable, the adaptor, and the rod radiator having a combined length being less than ¼λ for a VHF frequency band.

15. The antenna assembly of claim 14, wherein the cable includes an inner conductor and an outer conductor, the inner conductor and the outer conductor being direct coupled to each other at the mounting connector.

16. The antenna assembly of claim 14, further comprising a parasitic spring coil concentrically surrounding a portion of the cable separate from the bottom spring coil.

17. The antenna assembly of claim 14, wherein the cable is flexible to move the rod radiator relative to the mounting connector.

18. An antenna assembly comprising:
an antenna base including a ground plane;
a radome coupled to the antenna base such that an interior enclosure is collectively defined by the radome and the antenna base, the internal enclosure configured to hold at least one antenna element;
a whip antenna connector base mounted to the antenna base; and
a flexible whip antenna coupled to the whip antenna connector base, the flexible whip antenna including a first radiating element operable at a VHF frequency band, a second radiating element operable at a UHF frequency band, and a third radiating element operable at a 7/800 MHz frequency band.

19. The antenna assembly of claim 18, wherein the flexible whip antenna includes a mounting connector coupled to the whip antenna connector base, a cable coupled to the mounting connector, a bottom spring coil surrounding the cable and coupled to the mounting connector, an adaptor coupled to the cable, and a rod radiator coupled to the adaptor, the bottom spring coil defining the third radiating element, the cable defining the second radiating element, the radiating rod forming at least a portion of the first radiating element.

20. The antenna assembly of claim 19, wherein the cable forms at least a portion of the first radiating element.
